(19) United States
(12) Patent Application Publication
(10) Pub. No.: US 2006/0109987 A1
(43) Pub. Date: May 25, 2006

(54) BURGLAR PROOF CAR AUDIO SYSTEM CAPABLE OF ATTACHING AND DETACHING PORTABLE MP3 PLAYER AND CONTROL METHOD THEREOF

(76) Inventor: SEUNG HO BAEK, Icheon-si Gyeonggi-do (KR)

Correspondence Address: PARK LAW FIRM, 3255 WILSHIRE BLVD, SUITE 1110, LOS ANGELES, CA, 90010, US

(21) Appl. No.: 10/905,281

(22) Filed: Dec. 23, 2004

(30) Foreign Application Priority Data
Nov. 25, 2004 (KR) 10-2004-0097274

(51) Int. Cl. H04B 1/20; H04B 1/00

(52) U.S. Cl. 381/86; 369/2

(57) ABSTRACT

The preset invention discloses a burglar proof car audio system which can protect the car audio system against theft because a portable MP3 player is attachable and detachable thereto and the car audio system is operated only when the portable MP3 player is mounted thereto, and a control method thereof. The burglar proof car audio system capable of attaching and detaching a portable MP3 player comprises: a portable MP3 player which is supplied with a power from a vehicle and provided with a display unit for displaying a predetermined input data; and a car audio system which has the portable MP3 player integrally mounted thereto, operates by the power supplied upon mounting the portable MP3 player thereto, receives an audio signal input from the MP3 player and outputs the same through a speaker, and shares the display unit.

### BACKGROUND OF THE INVENTION

1. Field of the Invention

The present invention relates to a car audio system, and more particularly to, a burglar proof car audio system which can protect the car audio system against theft because a portable MP3 player is attachable and detachable thereto and the car audio system is operated when mounting the portable MP3 player, and a control method thereof.

2. Description of the Background Art

Generally, a car audio system is mounted to a vehicle in order for a driver to relieve the boredom of driving. Presently, the car audio system incorporates a variety of MP3 players including a radio, tape deck, CD player, television, DVD player, MP3 player, etc. Since the CD player, DVD player and/or MP3 player commonly use a CD or DVD media of a round shape having the same size, they utilizes one lens using the same one deck and capable of reading all of the CD, DVD and/or MP3 formats.

However, a conventional car audio system merely plays MP3 files stored on a disc, but cannot play music stored in a memory such as a flash memory. In order to read and play music files such as MP3 recorded on the flash memory or the like, an MP3 player having a memory must be purchased and a tape-type car pack for connecting a car audio system and the MP3 player or a connecting device of a frequency modulation (FM) type must be provided.

Such a car audio system mounted in a vehicle is currently being sold at a high price as it has been developed into a composite device incorporating various kinds of MP3 players, and a much higher cost will be paid in case that a driver purchases the MP3 player and the connecting device.

As car audio systems are being sold at a high price as set forth above, they are becoming targets for thieves and a large number of cases of theft actually happen.

As explained above, a conventional car audio system is problematic in that MP3 files stored in a memory cannot be listened to, and an additional cost is required since an MP3 player and a connecting device for connecting the MP3 player and the car audio system must be provided in order to listen to MP3 files stored in a memory.

Additionally, in the case of using a connecting device, the sound quality is deteriorated upon transmission and the interior of a vehicle looks messy.

Additionally, the conventional car audio system is easily stolen since it operates in the same manner eve if mounted to other vehicles.

### SUMMARY OF THE INVENTION

Therefore, an object of the present invention is to provide a car audio system which is capable of attaching and detaching a portable MP3 player, and a control method thereof.

Another object of the present invention is to provide a burglar proof car audio system which can protect the car audio system against theft because a portable MP3 player is attachable and detachable thereto and the car audio system is operated only when the portable MP3 player is mounted thereto, and a control method thereof.

To achieve the above objects, there is provided a burglar proof car audio system capable of attaching and detaching a portable MP3 player according to the present invention, comprising: a portable MP3 player which is supplied with a power from a vehicle and provided with a display unit for displaying a predetermined input data; and a car audio system which has the portable MP3 player integrally mounted thereto, operates by the power supplied upon mounting the portable MP3 player thereto, receives an audio signal input from the MP3 player and outputs the same through a speaker, and shares the display unit.

To achieve the above objects, there is provided another burglar proof car audio system capable of attaching and detaching a portable MP3 player according to the present invention, comprising: a portable MP3 player which stores a characteristic authentication code and is provided with a display unit for displaying a predetermined input display data; and a car audio body which stores a characteristic set authentication code, has the portable MP3 player integrally mounted thereto, compares the authentication code of the MP3 player and the stored set authentication code, operates if the two authentication codes are the same, receives an audio signal input from the MP3 player and outputs the same through a speaker, and shares the display unit.

To achieve the above objects, there is provided a control method of a burglar proof car audio system according to the present invention, wherein the burglar proof car audio system comprises a portable MP3 player storing a characteristic authentication code and a car audio body having the portable MP3 player integrally mounted and connected thereto and storing a characteristic set authentication code, comprising the steps of: connecting the MP3 player and the main body; the MP3 players' transmitting the authentication code to the main body if the MP3 player and the main body are connected; and the main body's checking whether the authentication code and the set authentication code are identical by comparison and activating the functions of the main body if they are identical.

### BRIEF DESCRIPTION OF THE DRAWINGS

FIG. 1 is a view showing a front view of a burglar proof car audio system according to the present invention;

FIG. 2 is a view showing the construction of the burglar proof car audio system according to the present invention;

FIG. 3 is a view for explaining the concept of burglary protection according to a first embodiment of the present invention;

FIG. 4 is a view for explaining the concept of burglary protection according to a second embodiment of the present invention;

FIG. 5 is a flow chart showing a control method of the burglar proof car audio system according to the second embodiment of the present invention;

FIG. 6 is a view showing an audio signal transmission procedure for transmitting an audio signal to a car audio body from a portable MP3 player according to the present invention;

FIG. 7 is a view showing a display data transmission procedure for transmitting display data to the portable MP3 player from the car audio body according to the present invention; and

FIG. 8 is a flow chart showing a method of recording an audio signal output from the car audio body by the portable MP3 player according to the present invention.

### DETAILED DESCRIPTION OF THE PREFERRED EMBODIMENTS

Hereinafter, preferred embodiments of the present invention will be described in detail with reference to the accompanying drawings. In the following description, it should be noted that only the elements necessary to understand the operation of the present invention will be described and a description of the other elements will be omitted not to deviate from the gist of the present invention.

The present invention allows a MP3 player to be attached to and detached from a car audio system, and allows a car audio system to be operated only when the above multimedia device is mounted. The present invention suggests a burglar proof car audio system which reduces the possibility of theft by making the car audio system not applicable to other vehicles in the event the car audio system has been stolen after a driver separated the MP3 player from the car audio system upon getting off the vehicle.

For the convenience of the following description, a car audio system for mounting the MP3 player thereto are referred to as a main body, and a system incorporating the MP3 player and the main body is referred to as a car audio system.

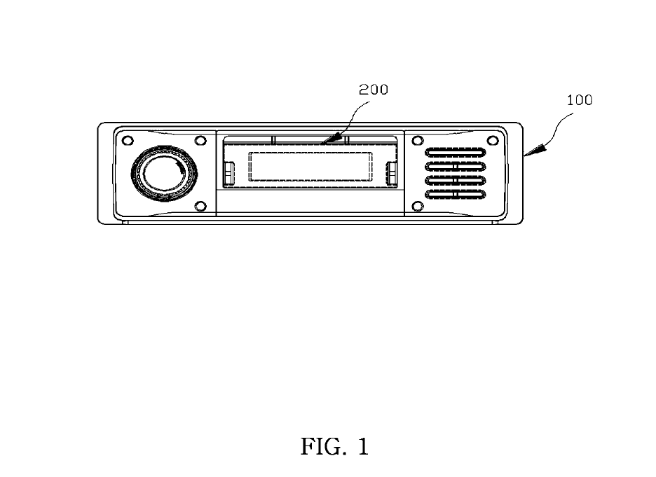

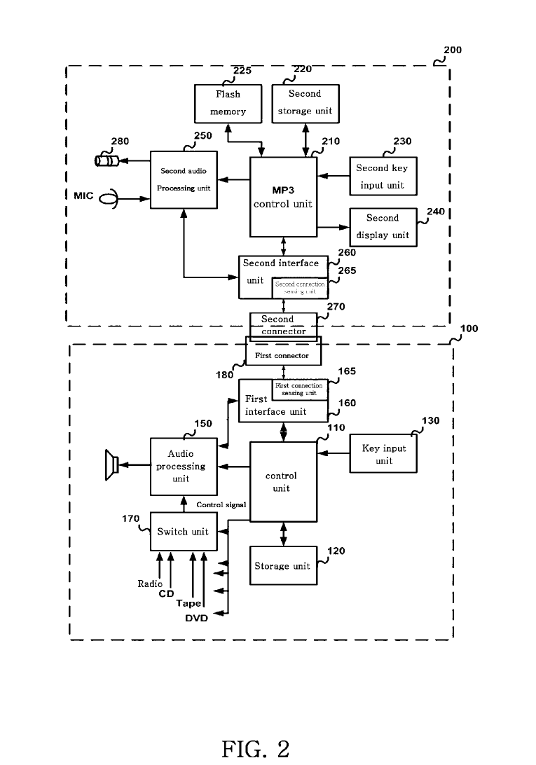

FIG. 1 is a view showing a front view of a burglar proof car audio system according to the present invention. FIG. 2 is a view showing the construction of the burglar proof car audio system according to the present invention.

Referring to FIGS. 1 and 2, reference numeral 100 denotes a car audios system main body and 200 denotes a portable MP3 player.

The car audio body 100 shares an audio processing unit and a speaker, which are to be described later and process and output sound, with the MP3 player 200. The portable MP3 player 200 shares with the main body 100 a display unit for visually displaying various information, such as an operation mode, channel, volume level and so on of the car audio system.

In FIG. 2, the main body 100 includes a control unit 110, a storage unit 120, a key input unit 130, an audio processing unit 150, a first interface unit 160, a switch unit 170 and a first connector 180.

The control unit 110 controls the overall operation of the burglar proof car audio system capable of attaching and detaching a portable MP3 player according to the present invention. The storage unit 120 stores a control program for controlling the burglar proof car audio system, and stores an authentication code according to a second embodiment of the present invention. The key input unit 130 is provided with a plurality of keys for channel selection, volume level control, mode selection, etc. and creates key data for the keys to output them to the control unit 110.

The first connector 180 provides a physical connection point with the portable MP3 player 100. The first interface unit 160 controls a signal interface with the portable MP3 player 100. As the first interface unit 160 an interface controller, such as a universal asynchronous bus or IEEE1394 or the like, can be used. Additionally, the first interface unit 160 includes a first connection sensing unit 165 for sensing a connection to the portable MP3 player 100 and providing a connection signal to the control unit 110.

The audio processing unit 150 processes an audio signal inputted through the first connector 180 and first interface unit 160 or an audio signal inputted through the switch unit 170 under control of the control unit 110 to output it to the speaker SP.

The switch unit 170 is turned on under control of the control unit 110 when the portable MP3 player 200 is connected to the fist connector 180 of the main body 100, and outputs an audio signal inputted from a radio, CD player, tape deck or DVD player to the audio processing unit 150. In case the portable MP3 player 200 is not connected to the main body 100, the switch unit 170 is turned off and thus the main body 100 is not operated.

Further, the switch unit 170 can be constructed such that it is turned on to supply a power to the functional components of the main body 100, for example, a radio, CD player, tape deck and/or DVD player, when connected to a power unit (not shown) and connected to the portable MP3 player 200, and it is turned off to cut off the power supply to the components when not connected thereto. In this case, a predetermined power for operating the control unit 110 and the first interface unit 160 has to be inputted.

The portable MP3 player 200 according to the present invention includes a MP3 control unit 210, a second storage unit 220, a second key input unit 230, a display unit 230, a second audio processing unit 250, a second interface unit 260, an earphone jack 280 and a microphone MIC.

The MP3 control unit 210 controls the overall operation of the portable MP3 player 100. The second storage unit 220 stores a control program according to the present invention, and stores the same authentication code as the authentication code stored in the storage unit 120. A flash memory 225 stores MP3 files and recorded files.

The second key input unit 220 is provided with a plurality of keys for MP3 file search and selection and mode setting, and creates key data for the keys to output them.

The second interface unit 260 interfaces signals with the main body 100, and utilizes the same method as the first interface unit 160 does.

The second display unit 240 displays file names for files stores in the flash memory 225 and various operating information under control of the MP3 control unit 210, and when connected to the main body 100, receives display data inputted from the main body 100 through the second interface unit 260 and the control unit 210 and displays them.

The second audio processing unit 250 encodes an audio signal inputted through the microphone MIC or an audio signal inputted from the second interface unit 260 under control of the MP3 control unit 210 to store it in the flash memory 225, and decodes MP3 files and recording files stored in the flash memory 225 to output them to the earphone jack 280.

In the present invention, the portable MP3 player 200 plays the role of the key for the car audio body 100. That is, if the portable MP3 player is not connected to the main body 100, the main body 100 is not operated.

In the present invention, a hardware-based method and a software-based method are used as the method in which the portable MP3 player 200 carries out the key function.

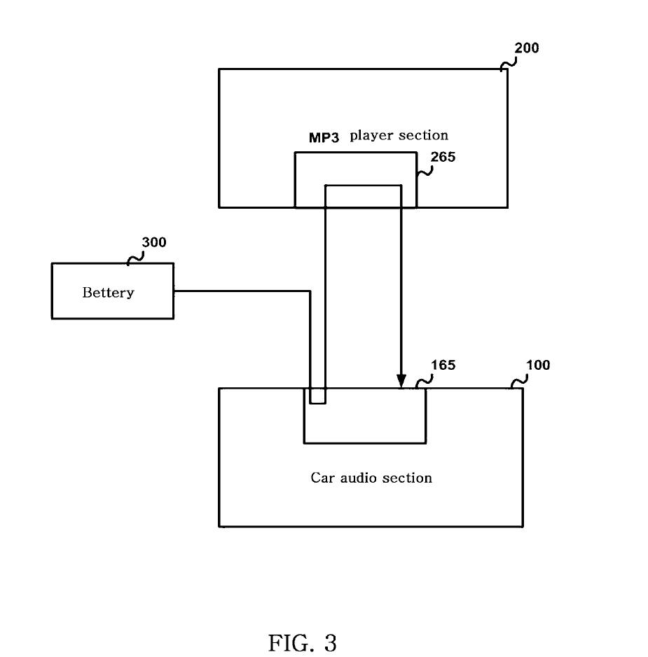

Firstly, referring to FIG. 3, the hardware-based method, the first method, is explained.

FIG. 3 is a view for explaining the concept of burglary protection according to a first embodiment of the present invention.

A power of a battery 300 is provided to the main body 100 of FIG. 2. However, the power of the battery 300 is not inputted to the respective components of the main body 100. The power of the battery 300 is inputted to the first connection sensing unit 165 of the main body 100 via a second connection sensing unit 265 of the portable MP3 player 200 when the portable MP3 player 200 is connected to the main body 100. Then, the first connection sensing unit 165 supplies power to the respective components of the main body 100. That is, unless the MP3 player 200 is connected to the main body, the main body 100 is not operated since the power is not supplied to the inside thereof.

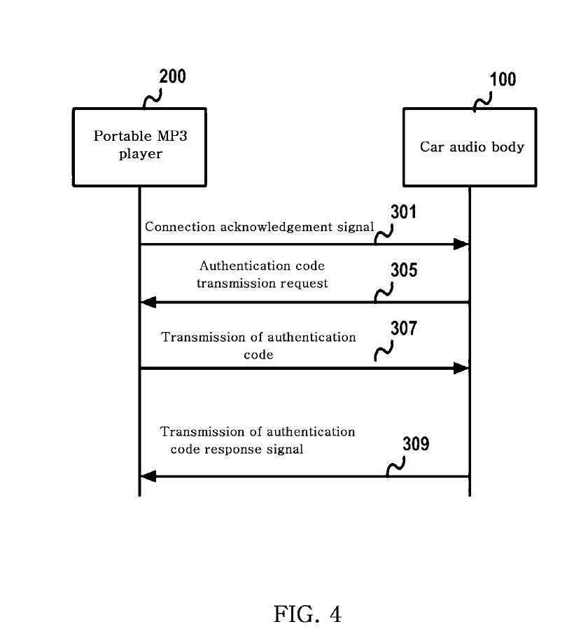

FIG. 4 is a procedure view for explaining the concept of burglary protection according to a second embodiment of the present invention, in which the software-based method according to the present invention will be explained.

In the second method, as set forth in FIG. 2, the portable MP3 player 200 and the main body 100 have authentication codes, and only in case the authentication codes are the same, the switch unit 170 of FIG. 2 is activated to thus operate the main body 100.

Firstly, when the first connector 180 and a second connector 270 are physically connected, the portable MP3 player 200 senses a connection through the second connection sensing unit 265 and transmits a connection acknowledgement signal to the main body 100 in step 301. Then, the main body 100 transmits to the portable MP3 player 200 a signal requesting for transmission of an authentication code in step 305. The portable MP3 player 200 transmits the authentication code stored in the second storage unit 220 to the main body 100 in response to the authentication code transmission request in step 307. The main body 100 having the input authentication code judges whether the authentication code stored in the storage unit 120 and the input authentication code are identical or not by comparison, and transmits an authentication code response signal in step 309. The above authentication code response signal has two types: one is an authentication acknowledgement signal that is transmitted if the input authentication code and the stored authentication code are identical and the other is an authentication failure signal that is transmitted if the two authentication codes are different. The authentication failure signal may incorporate a message saying, for example, “Wrong authentication code. The main body is not available”.

FIG. 4 shows the case in which the portable MP3 player 200 sends a connection acknowledgement signal. But the main body 100 can also send a connection acknowledgement signal.

Moreover, although, in FIG. 4, the portable MP3 player 200 transmits an authentication code after receiving an authentication code transmission request signal, it can also transmit the authentication code stored in the second storage unit 220 upon acknowledgement of a connection without receiving an authentication code transmission request signal.

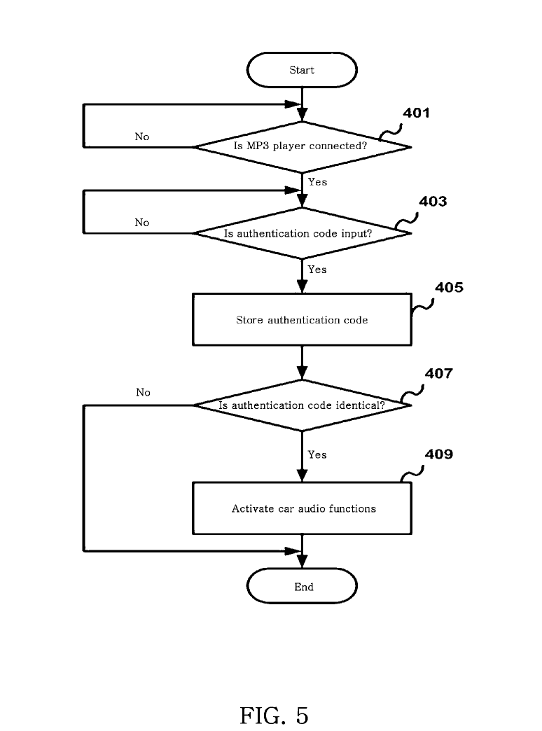

FIG. 5 is a flow chart showing a control method of the burglar proof car audio system according to the second embodiment of the present invention. Referring to FIG. 5, an authentication process by means of an authentication code from the main body will be explained concretely.

The control unit 110 checks whether the portable MP3 player 200 is connected in step 401. As in step 301 of FIG. 4, when a connection acknowledgement signal is received, the control unit 110 proceeds to step 401 and checks whether an authentication code is input from the portable MP3 player. When the authentication code is input in step 403, the control unit 110 proceeds to step 405 and stores the authentication code in the storage unit 120, and compares whether the input authentication code and an authentication code preset in the storage unit 120 are identical or not in step 407. If the authentication codes are identical in step 407, the switch unit 170 is turned on to activate the functions of the main body 100 in step 409.

When the portable MP3 player 200 is connected to the main body 100 by the aforementioned methods of FIGS. 3 to 5, the portable MP3 player 200 can share the audio processing unit 150 and speaker of the main body 100. Thus the MP3 files and recorded files stored in the flash memory 225 of the MP3 player can be output through the speaker SP of the main body 100. And the main body 100 shares the display unit 240 of the portable MP3 player 200 and is able to display various information such as channel information, track information, time information, etc. depending on the operation of a radio, CD player, tape, DVD player and so on.

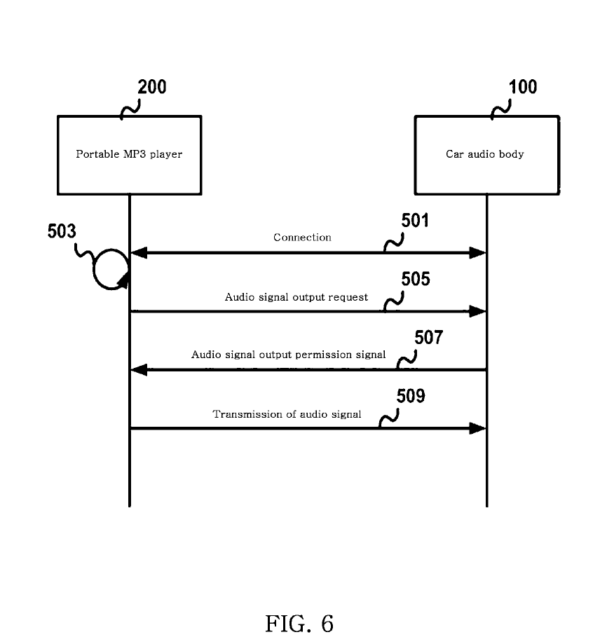

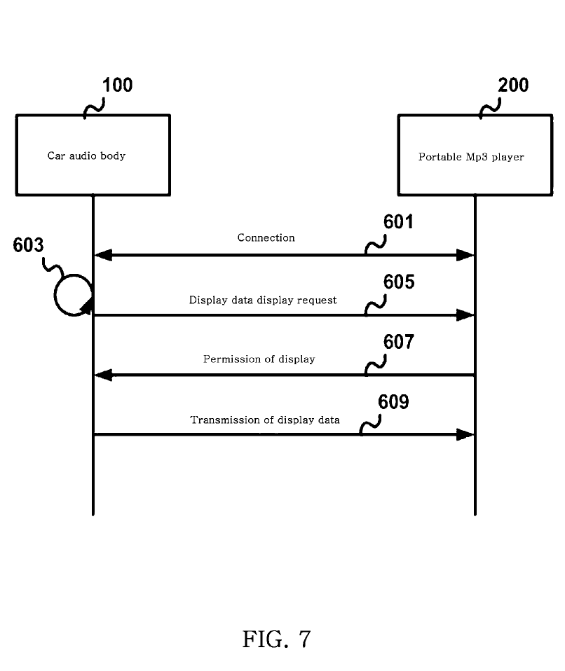

The method of mutually sharing the audio processing unit 150 and speaker of the main body 100 and the display unit of the portable MP3 player will now be explained with reference to FIGS. 6 and 7.

FIG. 6 is a view showing an audio signal transmission procedure for transmitting an audio signal to a car audio body from a portable MP3 player according to the present invention.

Firstly, after the portable MP3 player 200 and the main body 100 are connected by the aforementioned methods of FIGS. 3 to 5 in step 501, the portable MP3 player 200 judges whether a MP3 playback key is input in step 503. If the playback key is input, the portable MP3 player 200 transmits an audio signal output request signal to the main body 100 in step 505. The reason the audio signal output request signal is transmitted is to stop the operation of the main body 100 if the main body 100 is in an operation mode. The control unit 110 of the main body 100 having received the audio signal output request signal finishes the operating mode, and transmits an audio signal output permission signal to the portable MP3 player 200 in step 507. The portable MP3 player 200 having received the audio signal output permission signal reads MP3 files and recorded files from the flash memory 225 and transmits them to the main body 100.

FIG. 7 is a view showing a display data transmission procedure for transmitting display data to the portable MP3 player from the car audio body according to the present invention.

Like in step 501, after the main body 100 and the portable MP3 player 200 are connected in step 601, the portable MP3 player 200 judges whether any of radio, CD, tape and DVD modes is input from the key input unit 130 of the main body 100 in step 603. If any mode key is input in step 603, the control unit 110 of the main body 100 transmits a display data display request signal to the portable MP3 player 200 in step 605. The reason the display data display request signal is transmitted is to terminate the use of the display unit 240 if the portable MP3 player' 200 is using the display unit 240. The portable MP3 player 200 having received the display data display request signal stops its specific MP3 player operation and transmits to the main body 100 a display permission signal permitting the main body 100 to use the display unit 240 in step 607. The main body 100 having received the display permission signal transmits display data according to a corresponding mode in step 609. For instance, if radio mode is selected, the display data can be radio channel information, sound mode information, preset information, etc., and if CD or DVD mode is selected, the display data can be track information, sound mode information, play time information, etc.

Further, in the present invention, an audio signal output from the main body 100 can be recorded by the portable MP3 player.

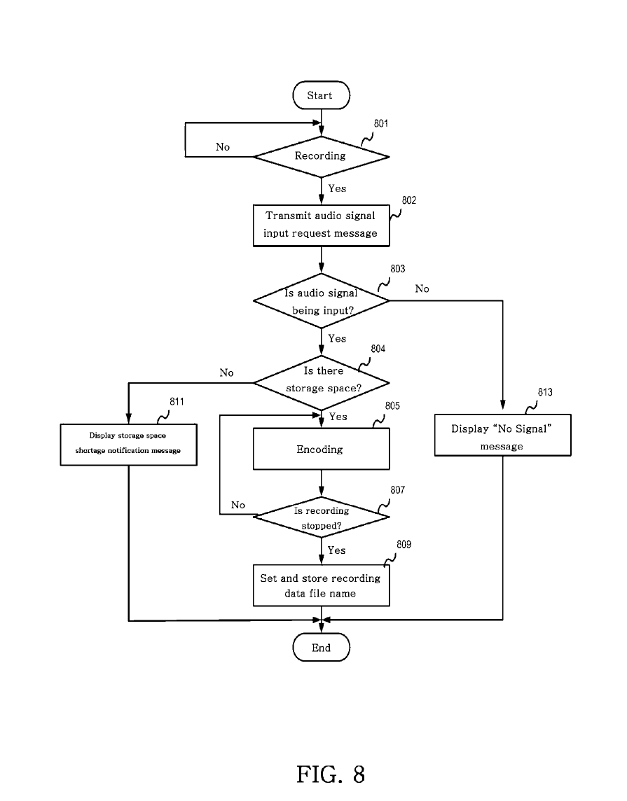

FIG. 8 is a flow chart showing a method of recording an audio signal output from the car audio body by the portable MP3 player according to the present invention.

The MP3 control unit 210 of the portable MP3 player 200 checks whether a recording key is input from the second key input unit 230 in step 801. If a recording key is input in step 801, the MP3 control unit 210 proceeds to step 802 and transmits an audio signal input request message to main body 100. The MP3 control unit 210 proceeds to step 803 and check whether and audio signal is being input from the main body 100 After the MP3 control unit 210 transmits the audio signal input request message. If an audio signal is being input, the MP3 control unit 210 proceeds to step 804, or if no audio signal is being input, the MP3 control unit 210 proceeds to step 813.

In step 813, the MP3 control unit 210 displays a message saying “No Signal” on the display unit 240 and then terminates the routine.

On the contrary, the MP3 control unit 210 that has proceeded to step 804 checks whether there is a storage space in the flash memory 225. If there is no storage space in the flash memory 225, the MP3 control unit 210 proceeds to step 811, displays a storage space shortage notification message saying “Short of storage space” and terminates the routine.

However, if there is a storage space, the MP3 control unit 210 proceeds to step 805 and starts to encode an input audio signal. When the encoding of the audio signal is started, the MP3 control unit 210 periodically performs step 807 and checks whether a recording stop key is input from the second input unit 230. If the stop key is input during the encoding, the MP3 control unit 210 proceeds to step 809, inputs a recording data file name and sets the same, and stores it in the flash memory 225. The recording data file name can be input directly by a user based on the method of selecting a consonant and a vowel, or can be optionally set by a given pattern.

As described above in detail, in the present invention, the portable MP3 player is detachable from the main body of the car audio system, and the main body is operated only when the portable MP3 player is mounted thereto. Accordingly, the theft of the car audio system can be protected by making thieves restrain their urge to steal the car audio system because, even if thieves steal the main body, the main body is not operated, the main body will not be operated.

Furthermore, MP3 files stored in the flash memory can be played back in the car audio system without purchasing any connecting device, and the portable MP3 player can be used as a general portable MP3 player upon removal.

What is claimed is:

1. A burglar proof car audio system capable of attaching and detaching a portable MP3 player, comprising:
a portable MP3 player which is supplied with a power from a vehicle and provided with a display unit for displaying a predetermined input data; and
a car audio system which has the portable MP3 player integrally mounted thereto, operates by the power supplied upon mounting the portable MP3 player thereto, receives an audio signal input from the MP3 player and outputs the same through a speaker, and shares the display unit.

2. The system of claim 1, wherein the portable MP3 player further includes a second interface unit for controlling a signal from/to the car audio body.

3. The system of claim 2, wherein the interface unit is a universal asynchronous bus controller.

4. The system of claim 2, wherein the interface unit is an IEeE1394 controller.

5. The system of claim 1, wherein the car audio body further includes a first interface unit for controlling a signal from/to the portable MP3 player.

6. The system of claim 5, wherein the interface unit is a universal asynchronous bus controller.

7. The system of claim 5, wherein the interface unit is an IEEE1394 controller.

8. A burglar proof car audio system capable of attaching and detaching a portable MP3 player, comprising:
a portable MP3 player which stores a characteristic authentication code and is provided with a display unit for displaying a predetermined input display data; and
a car audio body which stores a characteristic set authentication code, has the portable MP3 player integrally mounted thereto, compares the authentication code of the MP3 player and the stored set authentication code, operates if the two authentication codes are the same, receives an audio signal input from the MP3 player and outputs the same through a speaker, and shares the display unit.

9. The system of claim 8, wherein the main body further includes a switch unit which receives audio signals created according to the functional modes of the main body, is turned off when the portable MP3 player is not mounted thereto, and is turned on when the portable MP3 player is mounted to output the audio signals through the speaker.

10. The system of claim 8, wherein the portable MP3 player further includes a second interface unit for controlling a signal from/to the car audio body.

11. The system of claim 10, wherein the interface unit is a universal asynchronous bus controller.

12. The system of claim 10, wherein the interface unit is an IEEE1394 controller.

13. The system of claim 8, wherein the car audio body further includes a first interface unit for controlling a signal from/to the portable MP3 player.

14. The system of claim 11, wherein the interface unit is a universal asynchronous bus controller.

15. The system of claim 11, wherein the interface unit is an IEEE1394 controller.

16. A control method of a burglar proof car audio system, wherein the burglar proof car audio system comprises a portable MP3 player storing a characteristic authentication code and a car audio body having the portable MP3 player integrally mounted and connected thereto and storing a characteristic set authentication code, comprising the steps of:
connecting the MP3 player and the main body;
the MP3 players' transmitting the authentication code to the main body if the MP3 player and the main body are connected; and
the main body's checking whether the authentication code and the set authentication code are identical by comparison and activating the functions of the main body if they are identical.
